(19) United States
(12) Patent Application Publication
(10) Pub. No.: US 2016/0332900 A1
(43) Pub. Date: Nov. 17, 2016

(54) WATER TREATMENT APPARATUS AND METHOD OF USE

(71) Applicant: ARCH CHEMICALS, INC., Allendale, NJ (US)

(72) Inventor: Touraj ROWHANI, Alpharetta, GA (US)

(21) Appl. No.: 15/155,811

(22) Filed: May 16, 2016

Related U.S. Application Data
(60) Provisional application No. 62/162,093, filed on May 15, 2015.

(51) Int. Cl. C02F 1/68; C02F 1/00; C02F 1/50; E04H 4/12; C02F 1/66

(52) U.S. Cl. CPC C02F 1/68; E04H 4/1281; C02F 1/66; C02F 1/50; C02F 1/008; C02F 2103/42

(57) ABSTRACT

A water treatment apparatus for treating water with a solid treatment chemical that treats the water on an intermittent schedule is provided. Also provided is a cartridge containing a solid water treatment chemical which may be placed into the water treatment apparatus.

### RELATED APPLICATION

The present application is based on and claims priority to U.S. Provisional Patent application Ser. No. 62/162,093, filed on May 15, 2015, which is incorporated herein by reference.

### FIELD OF INVENTION

The present invention relates to a water treatment apparatus that adds chemicals to the water, and a method of treating water using the apparatus.

### BACKGROUND OF THE INVENTION

Some water treatment chemicals for pools, spas and the like need to be added to water in relatively small amounts on a regular schedule. Most of the time, these chemicals are added manually by the pool owner or pool maintenance company. However, this can be time consuming and require the owner or maintenance company to be at poolside on a regular basis to add these chemicals to maintain the correct balance of chemicals in water.

Other methods of adding pool chemicals such as dissolvable tables, slow release formulations and the like can be used as well. But depending on flow rates or lack of flow of the pool or spa water, using these dissolvable tablets, slow release formulations and the like can result in too much or not enough of the water treatment chemical being added to the pool, spa or body of water being treated.

Accordingly, there is a need in the art for an easy and convenient way to administer water treatment chemicals, which is a set and forget system that will operate on a set schedule. The present invention provides an answer to that need.

### SUMMARY OF THE INVENTION

In one aspect of the present invention, provided is an apparatus for administering a water treatment chemical to water. The apparatus has a water treatment module with a housing having a top, a side, and a bottom. The top and the bottom are connected to one another by the side, and the top, the side and the bottom form an interior compartment for holding a solid water treatment chemical.

The apparatus also has an inlet located in the housing. The inlet allows water to be contacted with the water treatment chemical to enter the housing. An outlet located is also present in the housing. The outlet allows the water contacted with the water treatment chemical to exit the housing. The apparatus further has a water distribution device, which is connected to the water inlet. The water distribution device is located within the interior compartment of the housing between the bottom and top of the housing. The water distribution device allows water entering the inlet to contact the water treatment chemical. To hold the water treatment chemical in place, there is at least one support located within the interior compartment positioned between the water distribution device and top of the housing. Also present in the apparatus is a water supply pipe connected to the inlet, a control valve located on the water supply pipe and a valve control module connected to the control valve. The valve control module serves to open and shut the control valve.

In another embodiment, the top of the housing has an opening which allows a water treatment chemical to be inserted into the housing. A cap is also present where the cap is adapted cover the opening of the housing and to form a water tight connection with the top of the housing.

A further embodiment of the cap, the cap is removable from the housing to reveal the opening and to allow the water treatment chemical to be inserted into the interior compartment of the housing.

In another aspect, the water distribution device is a spray nozzle. The spray nozzle sprays the water to be treated towards the top of the housing and directly into a water treatment chemical located in the interior compartment of the housing.

In another embodiment of the present invention, the apparatus has a removable cartridge. The removable cartridge has a first end, a second end, and a sidewall connecting the first end to the second end. The first end, second end and sidewall form an internal chamber and the internal chamber contains a water treatment chemical. The removable cartridge is adapted to fit into the interior compartment of the housing between the top of the housing and the at least one support located in the interior compartment of the housing. The removable cartridge may be inserted into the interior compartment thru an opening located at the top of the housing.

In a further embodiment of the apparatus with respect to the cartridge, the first end of the cartridge has a porous grid. The cartridge is positioned in the interior compartment of the housing and the cartridge is inserted into the housing such that the first end is positioned near water distribution device and the second end is positioned near the top of the housing.

In another embodiment of the present invention, the valve control module is a computer or a timer.

In yet another aspect of the valve control module, the valve control module is a timer, which opens and shuts the control valve on a set schedule.

In a further aspect of the present invention, the water treatment chemical is solid material and is a selected from a sanitizer, an algaecide, a clarifier, a pH adjuster, a water balancer. In one particular embodiment, the water treatment chemical is polyhexamethylene biguanide.

In further aspect of the present invention, the apparatus further has a second water supply pipe, where the second water supply pipe provides water to be treated with the water treatment chemical to the control valve. There may also be an inlet shut off valve located in the second water supply pipe.

In another aspect of the present invention, the apparatus further has a water transporting pipe connected to the outlet. There may also be a shut off valve located in the water transporting pipe.

In yet another aspect, provided is a method of treating water using the apparatus having the valve control module to open the valve for a period of time, then close the valve after the period of time.

In another aspect of the present invention, provided is a cartridge for a water treatment chemical. The cartridge has a first end, a second end, and a sidewall connecting the first end to the second end where the first end, second end and sidewall form an internal chamber. The internal chamber contains a water treatment chemical, and the cartridge being adapted to fit into an interior compartment of a water treatment apparatus. The first end of the cartridge has a porous grid to allow water to contact a water treatment chemical within the internal chamber.

These and other aspects will become apparent when reading the detailed description of the invention.

### BRIEF DESCRIPTION OF DRAWINGS

FIG. 1 shows an apparatus within the scope of the present invention.

FIG. 2 shows the housing with a removable top.

FIG. 3 shows the housing with a removable top and a cartridge which is inserted into the housing.

FIG. 4 shows a grid present on one end of the cartridge.

FIG. 5 shows the cartridge with a water treatment chemical in the cartridge in the form of multiple solids.

FIG. 6 shows the cartridge with a water treatment chemical in the cartridge in the form of a unitary structure.

### DETAILED DESCRIPTION OF THE PREFERRED EMBODIMENTS

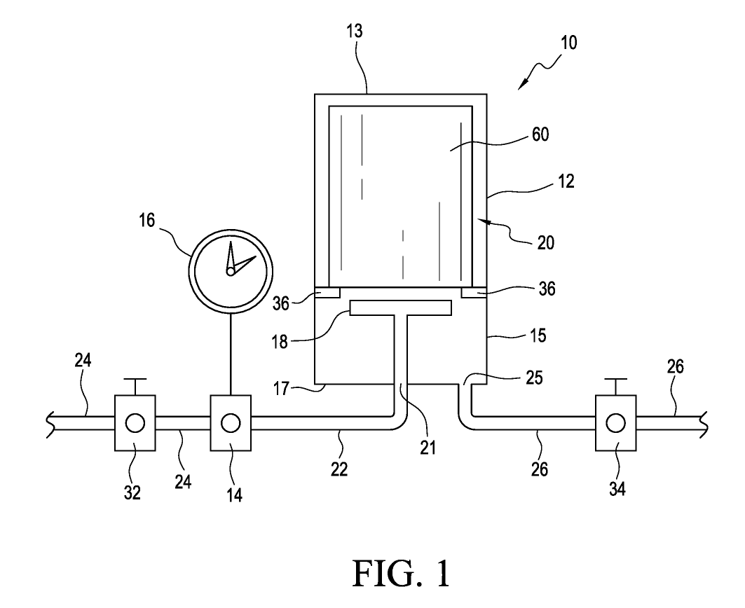

It has now been surprisingly found that the apparatus of the present invention is effective in administering solid water treating chemical. Referring to FIG. 1, the apparatus 10 for administering a water treatment chemical to water has a housing 12, having atop 13, a side 15, and a bottom 17, where the top 13 and the bottom 17 are connected to one another by the side 15. The top 13, the side 15 and the bottom 17 form an interior compartment 20. The interior compartment 20 is designed for containing a solid water treatment chemical. The side 15 may be a continuous surface, such as forming a cylindrical shape, or the side 15 may be a series on panels, forming a polygon shape cross-sectional shape, e.g. a triangle, a square, a pentagon, rectangle, or a hexagon, just to name a few. The shape of the side 15 is not critical to the function of the apparatus, but the shape of the side may be used to designate the type of chemical that is to be inserted into the apparatus. This will be described in more detail below.

The apparatus 10 also has an inlet 21 which is located in the housing 12. The inlet 21 is an opening located in the housing which allows water to be contacted with the water treatment chemical to enter the housing 12 thru the side 15 or the bottom 17, and allows the water to enter into the interior compartment 20. The inlet 21 will have an interior side located in the compartment 20 and an exterior side located on an outer surface of the housing. Also present is an outlet 25 located in the housing 12. The outlet 25 allows the water contacted with the water treatment chemical to exit the interior compartment 20 of the housing 12. Like the inlet 21, the outlet 25 has an interior side located in the compartment 20 and an exterior side, located on the outside of the housing. The outlet 25 may be located in the bottom 17 of the housing 12, as shown in FIG. 1, or may exit the housing 12 thru the side 15.

A water distribution device 18 is connected to the water inlet 21 of the housing 12 on the interior side of the inlet 21. The water distribution device 18 allows the water entering the housing 12 thru the inlet 21 to contact the water treatment chemical (not shown) which may be located cartridge 60 shown in FIG. 1. An exemplary water distribution device 18 includes a spray nozzle. Generally, the spray nozzle will generally spray the water to be treated towards the top 13 of the housing 12, thereby contacting the water treatment chemical. Any spray nozzle may be used, but it should be carefully selected to not to provide too much water pressure on the water treatment chemical.

Also connected to the inlet 21 on the exterior side is a first water supply pipe 22. The first water supply pipe 22 will have a control valve 14 connecting to an end of the first water supply pipe 22, which is opposite of the end of the first water supply pipe 22 connected to the inlet 21. Connected to the other end of the control valve 14 is a second water supply pipe 24, which provides water to be treated with the water treatment chemical to the control valve 14. The second water supply pipe 24 may have an inlet shut off valve 32 located in the second water supply pipe. The inlet shut off valve 32, allows the water to be stopped from entering the apparatus, for example during maintenance of the apparatus, for example, reloading the water treatment chemical into the interior compartment 20 of the housing 12.

Also connected to the control valve 14 is a valve control module 16. The valve control module 16 provides a signal to the control valve 14, which causes the control valve 14 to open or shut, depending on the current state of control valve 14. The valve control module 16 may open and shut the valve 14 on a set schedule for a period of time. The valve control module 16 may be a computer or a timer. The purpose of the valve control module 16 is to only provide water to be treated by contacting the water treatment chemical when the chemical is needed in the water. As an alternative to being set on a schedule, the valve control module 16 may be directly or indirectly connected to a sensor (not shown) which, directly or indirectly, provides an input to the valve control module 16. Valve control module 16 opens the control valve 14 when input provided to the valve control module 16 is outside of a set range. In one particular embodiment of the present invention, the valve control module 16 is a timer, which opens and closes the control valve 14 on a set schedule.

Connected to the outlet 25 is a treated water transporting pipe 26, which transports the water, treated with the treatment chemical, to the place of intended use. The treated water transporting pipe 26 may optionally have an outlet shut off valve 34 located in the pipe 26. The outlet shut off valve 34, allows the water to be stopped from exiting the apparatus 10, for example, during maintenance of the apparatus, e.g., reloading the water treatment chemical. It also serves the purpose to isolate the apparatus from the body of water being treated with the water treatment chemical. Optionally, the outlet shut off valve 34 may also be controlled by the valve control module 16.

Also present in the apparatus 10 is a support 36, located within the interior compartment 20 of the housing 12. The support 36 is on an interior surface of the side 15 of the housing 12 at a position between the water distribution device 18 and the top 13 of the housing 12. There may be one single support 36 or multiple supports at the same distance above the water distribution device. The single support 36 may be a continuous support, meaning the support completes a loop on the interior surface. The support 36 serve to support and position the water treatment chemical above the water distribution device 18, so that the water distribution device may contact the water to be treated with the water treatment chemical. In a particular embodiment, the support 36 may serve to hold a cartridge 60, which is described in more detail below, in place within the interior compartment 20 of the housing. The cartridge 60 will contain the water treatment chemical and position the water treatment chemical within the interior compartment 20 of the housing 12.

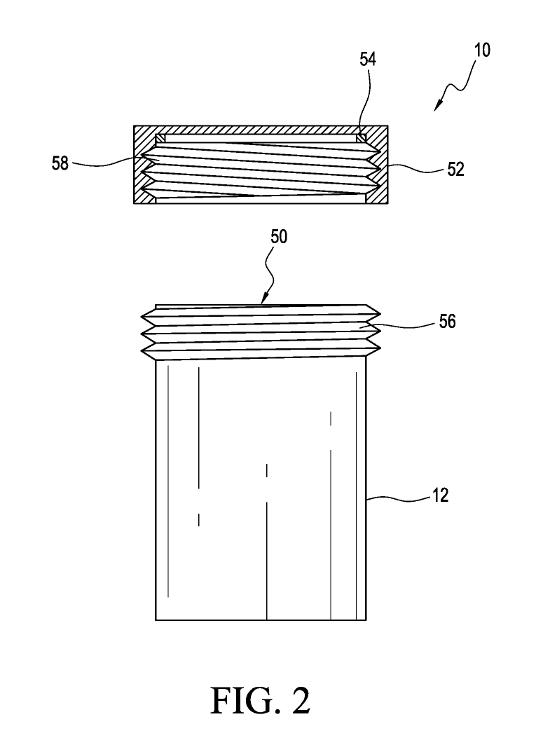

Referring to FIG. 2, the top 13 (not labelled) of the housing 12 further has an opening 50 and the apparatus 10 further has a cap 52 which is adapted to form a water tight connection with the top 13 of the housing 12. The cap 52 may be removable from the top 13 of the housing 12, which will allow the water treatment chemical to be inserted into the interior compartment 20 of the housing 12. Any suitable means may be used to create the water tight seal. An exemplary method includes having a seal 54 associated with the cap 52. In addition, as is shown in FIG. 2, the cap 52 may be threaded onto the top 13 of the housing. The top 13 of the housing is provided with threads 56 and the cap has complementary threads 58 located on a portion of the cap 52 that contacts the top 13. It is noted that other means to secure the cap 52 to the top 13 may be used without departing from the scope of the present invention. For example, the top 13 may be attached to the housing 12, in a way the top 13 pivots into position and locks into place to create a water tight seal.

Referring to FIG. 3, in the apparatus 10, the water treatment chemical is generally inserted into the interior compartment (not shown in FIG. 3) of the housing 12 thru the opening 50. The water treatment chemical may be the solid chemical itself, or the water treatment chemical may be located in a cartridge 60. The cartridge 60 is adapted to be inserted into the interior compartment of the housing 12 and the interior compartment of the housing 12 is adapted to receive the cartridge 60. The cartridge 60 is generally inserted thru opening 50 in the top 13 of the housing, as is shown in FIG. 3.

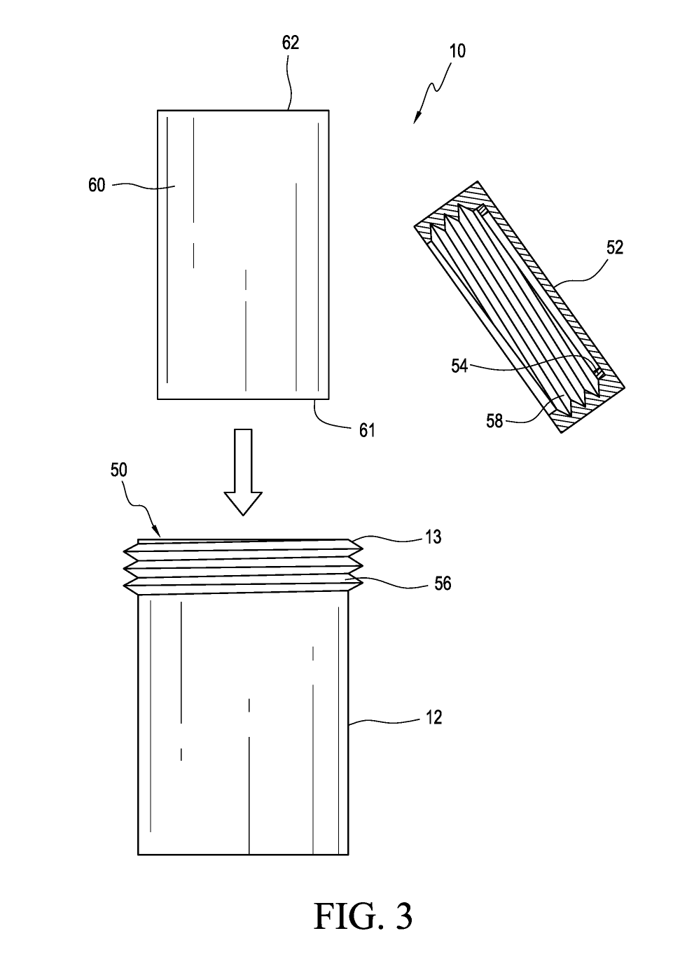

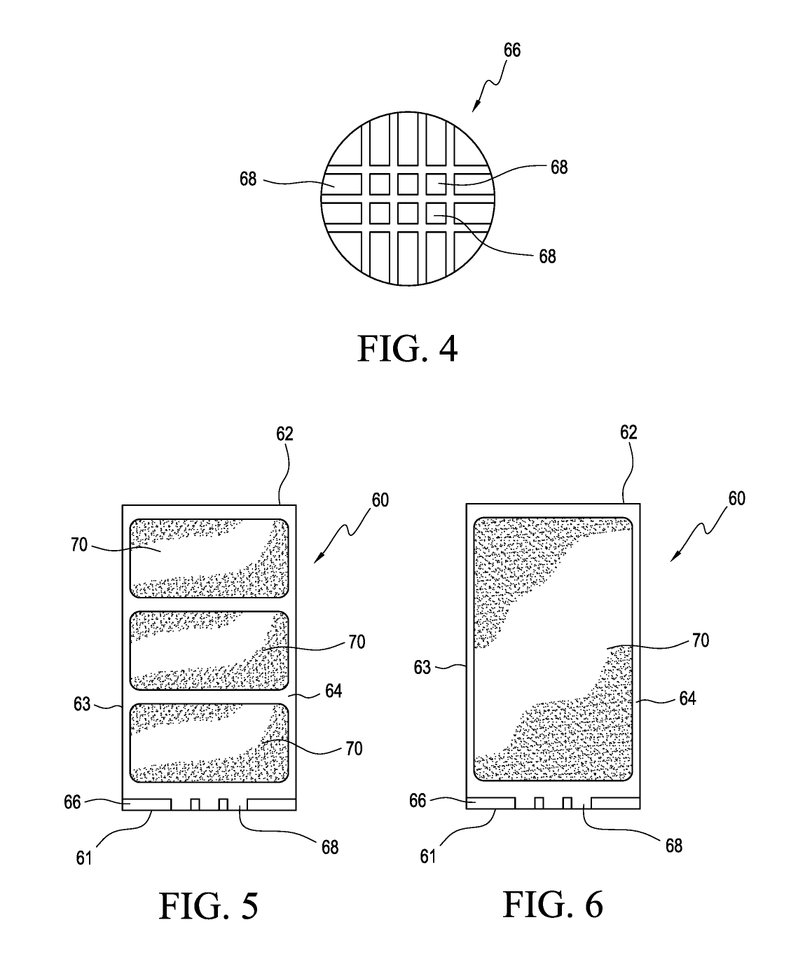

In one embodiment, the cartridge 60 will have a first end 61 and a second end 62. The cartridge 60 will also have a sidewall 63 (shown in FIGS. 5 and 6), which connects the first end 61 to the second end 62. The side wall 63, the first end 61 and the second end 62 form an internal chamber 64. The solid water treatment chemical 70 will be located in the internal chamber 64, as shown in FIG. 5 and FIG. 6. Typically, the first end 61 of the cartridge is placed into the housing 12, thru the opening 50 such that the first end 61 of the cartridge 60 is positioned near the water distribution device 18. The first end 61 of the cartridge 60 may have a porous grid 66, shown in FIG. 4, having openings 68 in the grid. The openings 68 allow water emitted from the water distribution device 18 to go through the grid 66 and contact the water treatment chemical 70, in the internal chamber 64 of the cartridge. Typically, as is shown in FIGS. 5 and 6, the cartridge 60 will contain a water treatment chemical 70 in the internal compartment. As shown in FIG. 5, the water treatment chemical 70 may be several distinct solid articles. Alternatively, as shown in FIG. 6, the water treatment chemical 70 may be a unitary structure. The first end 61 of the cartridge may be covered with a cap, a film, a foil and the like, or a combination thereof, to protect the water treatment chemical during storage and shipping. The second end may be closed or also covered a cap, a film, a foil and the like, or a combination thereof, to protect the water treatment chemical during storage and shipping. In one embodiment. the first end may be covered with a water soluble film that dissolves when water to be treated contacts the film from the water distribution device.

The grid 66 serves to hold the water treatment chemical 70 in the cartridge 60 so that the water treatment chemical does not directly contact the water distribution device 18. If a cartridge holding the water treatment chemical is not used, a grid or other similar structure will be used to hold the water treatment chemical spaced apart from the water distribution device 18 in the interior compartment 20 of the housing 12. Generally, the supports 36 (shown in FIG. 1) could be a grid structure, if, a cartridge is not used. Alternatively, support 36 may be a grid structure even if a cartridge is used. In such a case, it would not be necessary to provide the cartridge with a grid.

The cartridge 60 is adapted to be placed into the internal compartment 20 of the housing 12 and the housing 12 is adapted to receive the cartridge. By “adapted”, it is meant that the cartridge and internal compartment are sized and shaped to have the cartridge 60 to fit in the internal compartment 20 such that the cartridge will fit into and thru the opening 50 and the cap 52 can be positioned on the top 13 of the housing 12 to create a water tight seal. Generally, the shape of the cartridge 60 and the internal compartment 20 will be complementary, meaning they will each have a shape that allow proper placement of the cartridge 60 in the internal compartment 20.

The water treatment chemical usable in the apparatus of the present invention includes any solid water treatment chemical. The water treatment chemical may be a bromine releasing chemical, a chlorine releasing chemical, a peroxide releasing chemical, a biguanide releasing chemical and the like. The solid water treatment chemical may be a sanitizer, an algaecide, a clarifier, a pH adjuster, or a water balancer. One particular water treatment chemical is polyhexamethylene biguanide (PHMB). Another solid water treating chemical is calcium hypochlorite.

Also provided by the present invention is a water treatment system which will have multiple apparatus described above. The second or subsequent apparatus may be positioned in series or in parallel with the first apparatus. All of the apparatus may be controlled from a single control valve module or each may have its own control valve module. The second apparatus may have a housing which is different in shape from the first, so that the different water treatments chemicals may only be added to a particular apparatus.

The apparatus 10 of the present invention may be used to treat water which is present in a recirculating body of water, such as a swimming pool or spa, on an industrial body of water. Generally, the water being from the recirculated body of water is drawn through a pump in a recirculating line and the pipes 24 and 26 are connected on to the recirculating line.

In addition, the apparatus of the present invention may be used in conjunction with other water treatment devices, such as liquid chemical dispensing device, a chlorine generating device, an active hydroxyl generating device, an ozone generating device, an ultraviolet light device and the like. The additional devices may be separate units or built into a single unit. These additional devices may be in parallel or in series with the apparatus of the present invention.

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

What is claimed is:

1. An apparatus for administering a water treatment chemical to water, the apparatus comprising as water treatment module comprising:
(i) a housing, having a top, a side, and a bottom, where the top and the bottom are connected to one another by the side, said top, said side and said bottom form an interior compartment for containing a solid water treatment chemical;
(ii) an inlet located in the housing, the inlet allowing water to be contacted with the water treatment chemical to enter the housing;
(iii) an outlet located in the housing, the outlet allowing the water contacted with the water treatment chemical to exit the housing;
(iv) a water distribution device, connected to the water inlet, said water distribution device being located within the interior compartment of the housing between the bottom and top of the housing, wherein the water distribution device allows the water entering the inlet to contact the water treatment chemical;
(v) at least one support located within the interior compartment positioned between the water distribution device and top of the housing, said support is adapted to hold a solid water treatment chemical in place in the interior compartment;
(vi) a water supply pipe connected to the inlet;
(vii) a control valve located on the water supply pipe; and
(viii) a valve control module connected to the control valve, which opens and shuts the control valve.

2. The apparatus according to claim 1, wherein the top of the housing comprises an opening which allows a water treatment chemical to be inserted into the housing, and the apparatus further comprises a cap, said cap is adapted cover the opening of the housing and to form a water tight connection with the top of the housing.

3. The apparatus according to claim 2, wherein the cap is removable from the housing to reveal the opening and to allow the water treatment chemical to inserted into the interior compartment of the housing.

4. The apparatus according to claim 1, wherein the water distribution device comprises a spray nozzle.

5. The apparatus according to claim 4, wherein the spray nozzle sprays the water to be treated towards the top of the housing and directly into a water treatment chemical located in the interior compartment of the housing.

6. The apparatus according to claim 2, further comprising a removable cartridge, said removable cartridge having a first end, a second end, and a sidewall connecting the first end to the second end, the first end, second end and sidewall form an internal chamber, said internal chamber containing a water treatment chemical, and the removable cartridge being adapted to fit into the interior compartment of the housing between the top of the housing and the at least one support located in the interior compartment of the housing, and the removable cartridge may be inserted into the interior compartment thru said opening.

7. The apparatus according to claim 6, wherein the first end of the cartridge comprises a porous grid, and when the cartridge is positioned in the interior compartment of the housing, the cartridge being inserted in the housing such that the first end is positioned near water distribution device and the second end is positioned near the top of the housing.

8. The apparatus according to claim 1, wherein the valve control module comprises a computer or a timer.

9. The apparatus according to claim 8, wherein the control module valve module comprises a timer, wherein the timer opens and shuts the control valve on a set schedule.

10. The apparatus according to claim 1, wherein further comprising a water treatment chemical within the compartment, the water treatment chemical comprises a solid material selected from a sanitizer, an algaecide, a clarifier, a pH adjustment, a water balancer.

11. The apparatus according to claim 10, wherein the water treatment chemical comprises PHMB (polyhexamethylene biguanide).

12. The apparatus according to claim 1, further comprising a second water supply pipe, the second water supply pipe provides water to be treated with the water treatment chemical to the control valve.

13. The apparatus according to claim 1, further comprising a water transporting pipe connected to the outlet.

14. The apparatus according to claim 12, further comprising an inlet shut off valve located in the second water supply pipe.

15. The apparatus according to claim 13, further comprising an outlet shut off valve located in the water transporting pipe.

16. The apparatus according to claim 1, further comprising a second water treatment module comprising:
(i) a second housing, having a second top, a second side, and a second bottom, where the second top and the second bottom are connected to one another by the second side, said second top, said second side and said second bottom form a second interior compartment for containing a second solid water treatment chemical;
(ii) a second inlet located in the second housing, the second inlet allowing water to be contacted with the second water treatment chemical to enter the second housing;
(iii) a second outlet located in the second housing, the second outlet allowing the water contacted with the second water treatment chemical to exit the second housing;
(iv) a second water distribution device connected to the second water inlet, said second water distribution device being located within the second interior compartment of the second housing between the second bottom and second top of the second housing, wherein the second water distribution device allows the water entering the second inlet to contact the second water treatment chemical;
(v) at least one support located within the second interior compartment positioned between the second water distribution device and second top of the second housing, said support is adapted to hold a second solid water treatment chemical in place in the second interior compartment;
(vi) a second water supply pipe connected to the second inlet; and
(vii) a second valve located on the second water supply pipe.

17. The apparatus according to claim 16, wherein the valve control module is connected to the second control valve which opens and shuts the second valve.

18. The apparatus according to claim 16, further comprising a second valve control module.

19. The apparatus according to claim 16, wherein the second water treatment module is in series with the first water treatment module.

20. The apparatus according to claim 16, wherein the second water treatment module is in parallel with the first water treatment module.

21. A method of treating water comprising using the apparatus according to claim 1, having the valve control module to open the valve for a period of time, then close the valve after the period of time.

22. The method according to claim 18, wherein the water treatment chemical comprises a sanitizer, an algaecide, a clarifier, a pH adjuster, a water balancer.

23. The method according to claim 22, wherein water treatment chemical comprises PHMB (polyhexamethylene biguanide).

24. A cartridge for a water treatment chemical, said cartridge comprising a first end, a second end, and a sidewall connecting the first end to the second end, the first end, second end and sidewall form an internal chamber, said internal chamber containing a water treatment chemical, and the cartridge being adapted to fit into an interior compartment of water treatment apparatus, wherein the first end of the cartridge comprises a porous grid to allow water to contact a water treatment chemical within the internal chamber.
